(19) United States
(12) Patent Application Publication
(10) Pub. No.: US 2011/0191576 A1
(43) Pub. Date: Aug. 4, 2011

(54) INTEGRATION OF PRE REL-8 HOME LOCATION REGISTERS IN EVOLVED PACKET SYSTEM

(75) Inventors: Dan Forsberg, Helsinki (FI); Günther Horn, Munchen (FI); Marc Blommaert, Temse (BE)

(73) Assignee: NOKIA CORPORATION, Espoo (FI)

(21) Appl. No.: 12/810,983

(22) PCT Filed: Sep. 24, 2008
(86) PCT No.: PCT/EP2008/062730

§ 371 Date: Dec. 17, 2010

Related U.S. Application Data
(60) Provisional application No. 60/996,400, filed on Nov. 15, 2007.

(51) Int. Cl. H04L 9/00

(52) U.S. Cl. 713/150

(57) ABSTRACT

Cryptographic network separation functionality is provided on a user device. An option to store information about a type of database where a user is homed is provided in an indicator on a storage medium. An interface is provided between the user device and the storage medium for accessing the indicator. In case the information about the type of database cannot be obtained from the storage medium, it is determined not to enforce the cryptographic network separation functionality on the user device.

### FIELD OF THE INVENTION

The present invention relates to 3GPP (Third Generation Partnership Project) EPS (Evolved Packet System), also known as System Architecture Evolution (SAE). In particular, the invention relates to integrating Pre Rel-8 HLRs (Home Location Registers) in EPS where “Pre Rel-8” refers to functionality defined in 3GPP specifications published prior to the so-called 3GPP Release 8. It is evident from a particular version of a 3GPP specification to which release it belongs. EPS architecture is described in 3G TS 23.401 v1.2.1.

### BACKGROUND OF THE INVENTION

EPS users are equipped with a UICC (UMTS (Universal Mobile Telecommunications System) Integrated Circuit Card) with a USIM (User Services Identity Module) application for security purposes. User records are held in a Home Subscriber System (HSS) or a Home Location Register (HLR).

In order to achieve the full set of security benefits for EPS, the HSSs and HLRs need to be upgraded for EPS purposes (an upgraded HSS or HLR is called EPS-enabled HSS in the following). It is assumed that an HSS upgrade towards an EPS-enabled HSS is straightforward, which is not the case for the “old” HLR. However, due to the large number of users stored in existing pre Rel-8 HLRs, continued use of these “old” HLRs in EPS is desirable, at least in an initial phase even if the security benefits for users homed on these old HLRs could not be fully realised in this initial EPS phase, while allowing a smooth migration to an EPS-enabled HSS.

Such a smooth migration from old HLRs to EPS-enabled HSSs is not possible with the EPS security specification as it currently exists, at least not with respect to one important security feature, namely the cryptographic network separation of Authentication Vectors.

Cryptographic network separation means that security parameters, e.g. so-called Authentication Vectors (AVs), distributed by the HSS can only be used in the operator network (PLMN (Public Land Mobile Network)) and with the network technology (UMTS or EPS) for which they were established. This has the advantage that a security breach in one network does not spread across the whole system, or even more precisely: a compromise of a user's security data (i.e. AVs) in one network, e.g. a visited network, does not affect the user when he is in a different network, e.g. his home network. UMTS networks do not provide cryptographic network separation of the aforementioned user's security data.

Cryptographic network separation of user's security data as specified for EPS rests on the particular handling of an Authentication Management Field (AMF), which is part of an AV, in the HSS and a Mobile Equipment (ME). The ME is a User Equipment (UE) without the UICC.

As described in 3G TS 33.abc v0.2.0 (S3-070895), chapter 6, security procedures between UE and EPC (Evolved Packet Core) network elements comprising ASME (Access Security Management Entity) and HSS including Authentication Centre, comprise an Authentication and key agreement procedure (AKA). The EPS AKA produces keys forming a basis for user plane and control plane protection (ciphering, integrity). EPS AKA is based on following long term keys shared between UE and HSS:
K is the permanent key stored on the USIM (User Services Identity Module) and in the Authentication Centre AuC;
CK, IK is the pair of keys derived in the AuC and on the USIM during an AKA run.

As a result of the authentication and key agreement, an intermediate key K_ASME is generated which is shared between UE and ASME.

The purpose of this procedure is to provide an MME (Mobility Management Entity) with one or more MME security contexts (e.g. K_ASME) including a fresh authentication vector from the user's HSS to perform a number of user authentications.

An MME security context is derived from the authentication vector. To derive the key K_ASME in the HSS, a Key Derivation Function is used which contains input parameters CK, IK and SN (serving network) identity.

A “separation bit” in an AMF field is set to 1 to indicate to the UE that the authentication vector is only usable for AKA in an EPS context, if the “separation bit” is set to 0, the vector is usable in a non-EPS context only (e.g. GSM (Global System for Mobile communication), UMTS). For authentication vectors with the “separation bit” set to 1, the secret keys CK and IK generated during AKA never leave the HSS. More details can be found in 3G TR 33.821 (S3-070898).

Cryptographic network separation is achieved by realising the following three requirements:

1. The HSS does never issue an AV with Separation bit in the AMF set to 1 to a non-EPS network entity.

2. The HSS performs further key derivation from session keys CK (Ciphering Key), IK (Integrity Key) before sending an AV with Separation bit set to 1 to an EPS-MME (Mobility Management Entity) (or any other EPS entity). If the separation bit is set to 1, then CK and IK do not leave the HSS.

3. An ME attaching to an EPS access network checks during authentication that Separation bit is set to 1 and aborts authentication if this is not the case.

Requirements 1 and 3 cannot be fulfilled when using an old HLR. If now the user is homed on an old HLR and the ME behaves according to requirement 3 then there will be a conflict, and network access will fail if the old HLR accidentally sets the Separation bit to 0.

On the other hand, if the ME does not perform the check according to requirement 3 then it will not be possible to achieve cryptographic network separation even if the HSS is EPS-enabled and acts according to requirements 1 and 2 above. The problem is that the ME is not bound to a user, only a UICC is, and that the ME therefore does not know whether the user is homed on an old HLR or a new HSS. A UICC may be removed from one ME and inserted into another ME at any time.

Deferring the introduction of cryptographic network separation to a later 3GPP release of EPS will not solve this problem as MEs from the first release of EPS, i.e. from 3GPP Release 8, not yet supporting the feature, will still have to be allowed access to EPS. Then these “first release” MEs will not enforce cryptographic network separation so that the network operator never has assurance that this security feature is in use. Furthermore, operators may continue to use old HLRs for a long time, leading to the above-mentioned conflict and failed network access.

There is an additional problem that relates to the use of old HLRs in EPS. According to requirement 2 above, an EPS-enabled HSS performs further key derivation from the session keys CK, IK before sending them on to the Mobility Management Entity (MME), while an old HLR does not do this and sends CK, IK to the MME. In this latter case, the MME needs to perform the further key derivation. The result of this further key derivation is the key K_ASME (Access Security Management Entity).

### SUMMARY OF THE INVENTION

The present invention aims at providing a method, a user device, a network system and a storage medium which enable cryptographic network separation of user security data together with a smooth migration from a system without such a property.

The invention may also be implemented by a computer program product.

According to an embodiment of the invention, a method is provided, comprising:
providing cryptographic network separation functionality on a user device;
providing an option to store information about a type of database where a user is homed in an indicator on a storage medium;
providing an interface between the user device and the storage medium for accessing the indicator; and
in case the information about the type of database cannot be obtained from the storage medium, determining not to enforce the cryptographic network separation functionality on the user device.

In case the information can be obtained and the indicator is set, authentication information may be evaluated, including a separation indicator received from a network during authentication between the user device and the network, and if the separation indicator is set, it may be proceeded with the authentication, and if the separation indicator is not set, the authentication may be aborted.

The indicator on the storage medium may be set if the user is homed in a home subscriber system supporting an evolved packet system.

According to an embodiment of the invention, a user device is provided, comprising:
an interfacing unit configured to interface the user device with a storage medium;
a processing unit configured to check, using the interfacing unit, if an indicator indicating information about a type of database where a user is homed is present on the storage medium, in case the indicator is present, check whether the indicator is set, and in case the indicator is set, evaluate authentication information including a separation indicator received from a network during authentication between the user device and the network.

If the separation indicator is set, the processing unit may proceed with the authentication on the user device, and if the separation indicator is not set, abort the authentication.

If the separation indicator is set, the processing unit may perform key derivation from a ciphering key and an integrity key to obtain a derived key.

The user device may comprise a transmitting unit configured to transmit separation enforcement information to the network in an initial network attachment message.

The user device may comprise the storage medium.

According to an embodiment of the invention, network system is provided, comprising:
a network device managing mobility of a user of the network system; and
a first database supporting a cryptographic network separation functionality, wherein the first database is configured to receive an identity of the user from the network device, and perform key derivation from a ciphering key and an integrity key based on the identity to obtain a derived key,
wherein the network device is provided with information on whether a key derivation from a ciphering key and an integrity key to obtain a derived key is to be performed by the network device.

The first database may store presence and setting of an indicator, located on a storage medium, about a type of database where the user is homed, and receive an identity of the user from the network device, and perform the key derivation from the ciphering key and the integrity key based on the identity to obtain the derived key only in case the indicator is present and set.

The network device may perform the key derivation from the ciphering key and the integrity key to obtain the derived key in case the network device receives separation enforcement information from a user device with a cryptographic network separation functionality which separation enforcement information indicates that no separation enforcement is performed.

The network system may comprise a second database not supporting the cryptographic network separation functionality, wherein the second database is configured to indicate this by separation information, and the network device may perform the key derivation from the ciphering key and the integrity key to obtain the derived key in case the network device receives the separation information from the second database indicating that the cryptographic network separation functionality is not supported by the second database.

The first database may transmit an indication to the network device that it supports the cryptographic network separation functionality, and the network device may perform the key derivation from the ciphering key and the integrity key to obtain the derived key in case the network device does not receive the indication.

According to an embodiment of the invention, a computer-readable storage medium is provided, storing a program for causing a computer to execute:
checking if an indicator indicating information about a type of database where a user is homed is present on a storage medium;
in case the indicator is present, checking whether the indicator is set; and
in case the indicator is set, evaluating authentication information including a separation indicator received from a network during authentication between the user device and the network.

According to an embodiment of the invention, a storage medium is provided, storing an indicator indicating information about a type of database where a user is homed, the storage medium being readable by a user device.

According to an embodiment of the invention,

a) all functionality required for cryptographic network separation is provided on MEs;

b) an option to store information about a type of HSS or HLR where a user is homed is provided in a “separation enforcement bit” on a storage medium, e.g. a UICC or ME internal memory;

c) an extension to an ME-UICC interface is specified so that the ME can access the “separation enforcement bit” on the UICC;

d) in case the ME cannot obtain such information from the storage medium, e.g. a UICC or ME internal memory, the default behaviour of the ME is not to enforce cryptographic network separation of users security data.

According to the invention it is possible to gradually introduce stronger security into the EPS in the following way: An operator may launch EPS using old HLRs. The operator may issue UICCs not supporting the separation enforcement bit, or UICCs supporting the separation enforcement bit with the value set to zero. At some later point in time, the operator may migrate to EPS-enabled HSSs, and move some or all of his users there. For users moved to an EPS-enabled HSS, the operator may at the same time or some time later issue new UICCs supporting the “separation enforcement bit” with the value set to 1, or change the “separation enforcement bit” to 1 by over-the-air means, if already present, or configure the “separation enforcement bit” into the storage medium on the ME if it cannot be configured on the UICC. In this way, the operator can ensure a smooth migration to a situation where gradually all users will enjoy the added security benefit of cryptographic network separation of users security data.

According to the prior art, the MME does not a priori know whether it requests and receives authentication data from an EPS-enabled HSS or an old HLR. However, the MME needs to know so that it can decide whether to perform further key derivation or not. Therefore, additional provisions are needed to allow the MME to distinguish between EPS-enabled HSS and old HLR. Such provisions are also part of the invention.

According to an embodiment of the invention, an MME is enabled to know whether it requests and receives authentication data from an EPS-enabled HSS or an old HLR. The MME is provided with information whether it requests and receives authentication information, i.e. AVs, from an EPS-enabled HSS or an old HLR. This knowledge enables the MME to decide whether the further key derivation from the session keys CK, IK has already been performed or needs to be performed in the MME.

### BRIEF DESCRIPTION OF THE DRAWINGS

FIG. 1 shows a flow chart illustrating a method of deciding on cryptographic network separation performed in an ME according to an embodiment of the invention.

FIG. 2 shows a signaling diagram illustrating signaling between an ME 10, an MME 20, an HSS 30 and an HLR 40 according to embodiments of the invention.

FIG. 3 shows a schematic block diagram illustrating an arrangement of a user device 310 and a storage medium 320 according to an embodiment of the invention.

### DESCRIPTION OF THE EMBODIMENTS

According to an embodiment of the invention, an option to store information about a type of database, e.g. HSS or HLR, where a user is homed is provided in an indicator, e.g. a “separation enforcement bit”, on a storage medium, e.g. a UICC.

According to the invention it is assumed that two types of UICCs may be used to access EPS, i.e. UICCs with a separation enforcement bit, and UICCs without the separation enforcement bit.

According to an embodiment of the invention, MEs are capable of determining whether the separation enforcement bit is present, and, if yes, read its value from the storage medium e.g. the UICC or ME internal memory.

According to the invention, both EPS-enabled HSSs and old HLRs may be present in EPS. EPS-enabled HSSs do not issue an AV with Separation bit in AMF set to 1 to a non-EPS network entity, and perform further key derivation from session keys CK (Ciphering Key), IK (Integrity Key) before sending an AV with Separation bit set to 1 to an EPS-MME (Mobility Management Entity) (or any other EPS entity). If the separation bit is set to 1, then CK and IK do not leave the HSS. Old HLRs do not follow these requirements.

According to an embodiment of the invention, the “separation enforcement bit” on the storage medium e.g. the UICC or ME internal memory is set to 1 only if the user is homed on an EPS-enabled HSS.

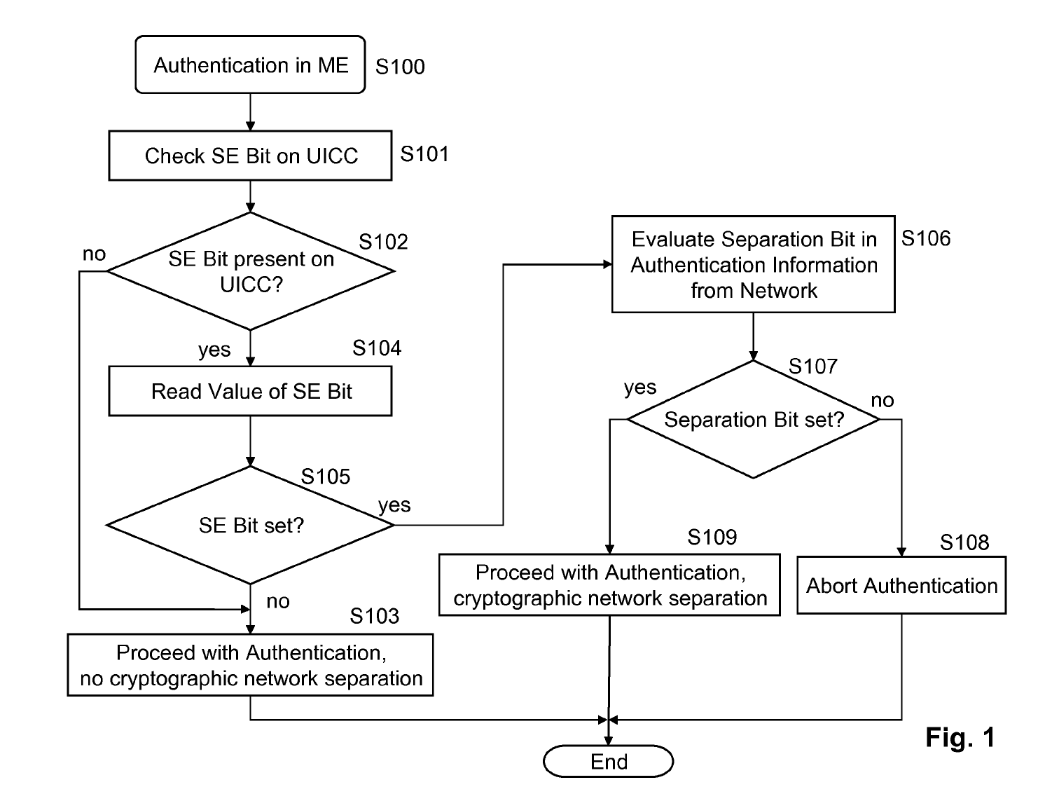

In the following an embodiment of the invention will be described with reference to FIG. 1.

As shown in FIG. 1, an ME attaching to an EPS access network behaves as follows during authentication (S100). In step S101 the ME checks whether SE (separation enforcement) bit is present on a storage medium e.g. the UICC or ME internal memory. If there are several such storage mediums the ME checks them starting with the UICC. The information on the UICC shall take precedence over the information in other storage media (e.g. ME internal memory). If the separation enforcement bit on the storage medium (e.g. the UICC or ME internal memory) is not present (no in step S102), a separation indicator, e.g. a separation bit in AMF of authentication information, received from the network during authentication is not evaluated and the ME proceeds with the authentication without performing cryptographic network separation (step S103). If the separation enforcement bit on the storage medium (e.g. the UICC or ME internal memory) is present (yes in step S102), the ME reads the value of this bit from the storage medium (e.g. the UICC or ME internal memory) (step S104), and if the value is 1 (i.e. the SE bit is set (to 1)) (yes in step S105) then the ME checks whether the separation bit in the AMF of the authentication information received from the network is also set, i.e. set to 1 (step S106). If the separation bit is not set, i.e. its value is not 1, (no in step S107), the ME aborts the authentication (step S108). If the separation bit in the AMF is set to 1 (yes in step S107), the ME proceeds with the authentication performing cryptographic network separation (step S109).

In case the value of the SE bit is not 1, i.e. the SE bit is not set, (no in step S105), the separation indicator is not evaluated and the process proceeds to step S103.

Due to the requirement that the HSS performs further key derivation from the session keys before sending the AV with the separation bit set to 1 to an EPS entity, according to an embodiment of the invention the ME always performs further key derivation from CK, IK to obtain K_ASME when attached to an EPS network.

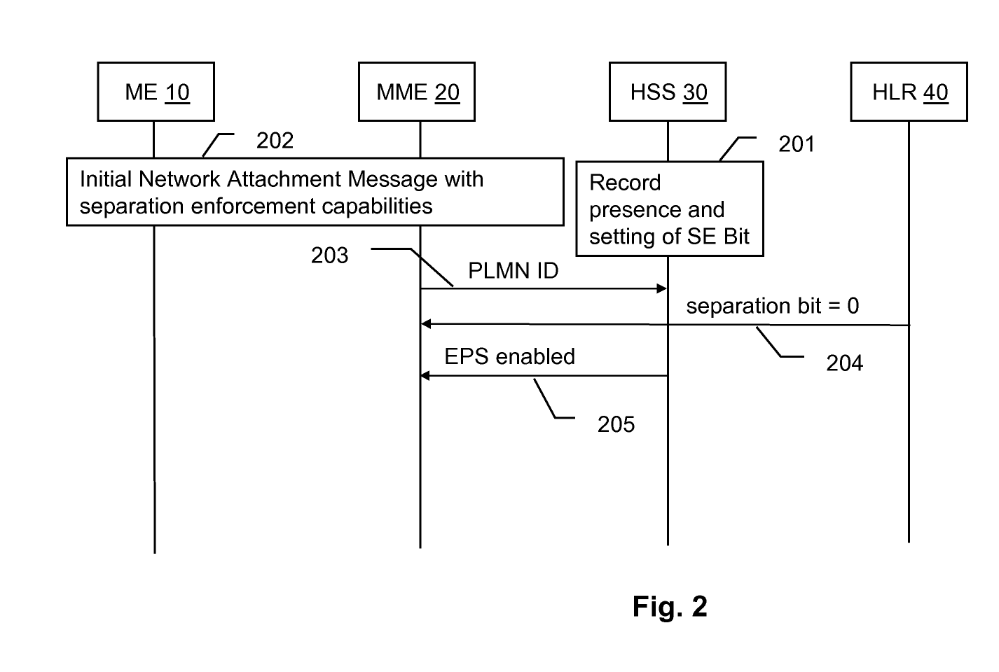

Further embodiments of the invention will be described in the following with reference to FIG. 2 which illustrates signaling between an ME 10, an MME 20, an HSS 30 and an HLR 40. The HSS 30 is EPS-enabled, the HLR 40 is not EPS-enabled.

According to an embodiment, the HSS 30 records presence and setting of the separation enforcement bit on the UICC or ME internal memory (201) and performs further key derivation from CK, IK to obtain K_ASME if and only if the separation enforcement bit is set to 1.

The ME 10 checks for the separation enforcement bit on the UICC or ME internal memory before sending an initial network attachment message 202 to the network and includes information whether it will perform separation enforcement in its UE capabilities sent to the network in the initial network attachment message 202.

Based on this information, the MME 20 will perform further key derivation from CK, IK to obtain K_ASME if and only if the ME 10 will not perform separation enforcement, i.e. if and only if the separation enforcement bit is set to 0. In order to enable the further key derivation from CK, IK to K_ASME on the HSS 30, the HSS 30 needs to receive the requesting PLMN-ID from the MME 20 (203). This parameter is defined in MAP (Mobile Application Part) protocol from 3GPP Release 6 onwards. In order to make the requesting PLMN-ID available for the HSS 30, the HSS 30, MME 20 and all Interworking Functions (IWFs) (not shown) support the MAP protocol from 3GPP Release 6 onwards for the sendAuthenticationInfo message, or support similar functionality for the DIAMETER protocol.

According to this embodiment, a first database supporting a cryptographic network separation functionality, e.g. the HSS 30, stores presence and setting of an indicator, e.g. the SE bit, located on a storage medium, e.g. the UICC or ME internal memory, about a type of database where the user is homed (S201). In case the indicator is present and set to 1, the first database receives an identity of the user from a network device managing mobility of the user, e.g. the MME 20 (203), and performs key derivation from a ciphering key (CK) and an integrity key (IK) based on the identity to obtain a derived key (K_ASME).

The network device, e.g. the MME 20, may perform the key derivation from the ciphering key and the integrity key to obtain the derived key in case the network device receives separation enforcement information from a user device with a cryptographic network separation functionality, e.g. the ME 10, which separation enforcement information indicates that no separation enforcement is performed, i.e. SE bit is set to 0 (201).

According to an alternative embodiment, the separation bit in the AMF is initialized to 0 by the HLR 40 for all AVs generated by the HLR independent of the requesting network entity. (204). This is achieved e.g. by reconfiguration of the HLR 40 for use in EPS e.g. by administration, or by software patching dependent on the type of HLR. Then the separation bit in the AMF can be used by the MME to distinguish whether the received AV was generated by an HLR or an HSS as an HSS always generated AVs with separation bit in the AMF set to 1 when the AVs are destined towards an MME in an EPS. Then the MME 20 may decide to perform further key derivation from CK, IK to K_ASME only if the separation bit in the AMF is set to zero. If it is set to 1 the MME 20 assumes it received AVs from the HSS 30 and that the key derivation has already been done in the HSS 30.

According to this embodiment, a second database not supporting the cryptographic network separation functionality, e.g. the HLR 40, indicates this by separation information (204), and the network device, e.g. the MME 20, performs the key derivation from the ciphering key and the integrity key to obtain the derived key in case the network device receives the separation information from the second database indicating that the cryptographic network separation functionality is not supported by the second database.

According to a further alternative embodiment the EPS-enabled HSS 30 signals the property of being EPS-enabled to the MME 20 (205). In the absence of such signaling information the MME 20 assumes that it received the AVs from the HLR 40 and performs further key derivation from CK, IK. In order to enable this property signaling towards the MME both the signaling protocols MAP and DIAMETER are enhanced to include this signaling information, and all IWFs (Interworking Functions) support this modification.

According to this embodiment, the first database, e.g. the HSS 30, transmits an indication to the network device that it supports the cryptographic network separation functionality (205). Then the network device, e.g. the MME 20, performs the key derivation from the ciphering key and the integrity key to obtain the derived key only in case the network device does not receive such indication.

All three alternatives shown in FIG. 2 provide an MME with information whether it requests and receives authentication information, i.e. AVs, from an EPS-enabled HSS or an old HLR. This knowledge enables the MME to decide whether the further key derivation from the session keys CK, IK has already been performed or needs to be performed in the MME. Alternative 1 (201-203) has an advantage over the other two alternatives that it does not make any further assumptions on the Authentication Centre or the interface between HSS and MME. Alternatives 2 (204) and 3 (205) have an advantage that an EPS-enabled HSS can always perform the further key derivation from CK, IK, and hence there is no need to send CK, IK outside the HSS even in case the separation enforcement bit is not set to 1 in the UICC. This is a security advantage.

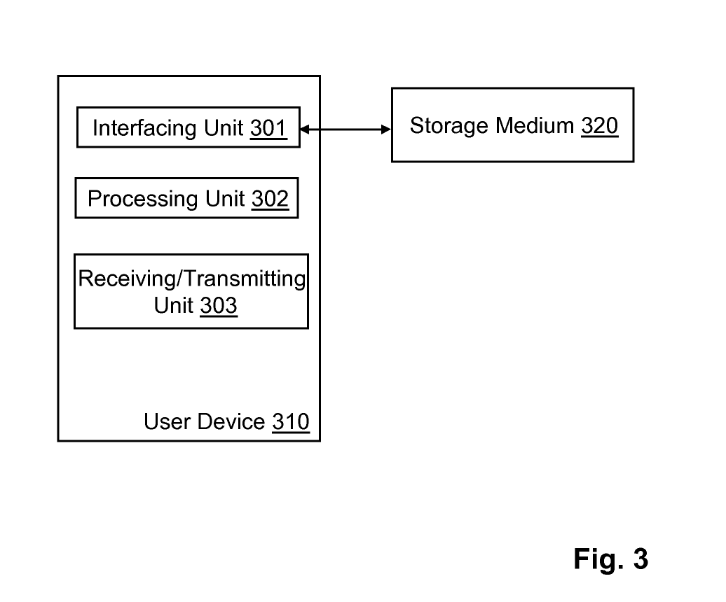

FIG. 3 shows a schematic block diagram illustrating an arrangement of a user device 310 and a storage medium 320 according to an embodiment of the invention. The user device 310 may comprise a user equipment, and the storage medium 320 may comprise a UICC.

The user device 310 comprises an interfacing unit 301 and a processing unit 302, and may further comprise a transmitting/receiving unit 303.

The interfacing unit 301 interfaces the user device 310 with the storage medium 320 on which an indicator, e.g. a separation enforcement bit, indicating information about a type of database where a user is homed may be stored.

The processing unit 302 checks, using the interfacing unit 301, if the indicator is present on the storage medium 320. In case the indicator is present, the processing unit 302 checks whether the indicator is set, i.e. is set to 1, and in case the indicator is set to 1, evaluates the separation indicator, e.g. the separation bit in the AMF in authentication vectors, received from a network during authentication between the user device and the network, as described in the following paragraph.

If the separation bit in the AMF is set, i.e. is set to 1, the processing unit 302 proceeds with the authentication on the user device 310, and if the separation bit in the AMF is not set, i.e. is set to 0, aborts the authentication.

If the authentication vector is received from an EPS network, the processing unit 302 is to perform key derivation from a ciphering key and an integrity key to obtain a derived key.

The transmitting unit 303 may transmit separation enforcement information to the network in an initial network attachment message.

It is to be noted that the user device shown in FIG. 3 may have further functionality for working e.g. as user equipment. Here the functions of the user device relevant for understanding the principles of the invention are described using functional blocks as shown in FIG. 3. The arrangement of the functional blocks of the user device is not construed to limit the invention, and the functions may be performed by one block or further split into sub-blocks.

For the purpose of the present invention described above, it should be noted that
method steps likely to be implemented as software code portions and being run using a processor at one of the mobile/network entities are software code independent and can be specified using any known or future developed programming language;
method steps and/or devices likely to be implemented as hardware components at one of the mobile/network entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

It is to be understood that the above description is illustrative of the invention and is not to be construed as limiting the invention. Various modifications and applications may occur to those skilled in the art without departing from the true spirit and scope of the invention as defined by the appended claims.

1. A method comprising:
providing cryptographic network separation functionality on a user device;
providing an option to store information about a type of database where a user is homed in an indicator on a storage medium;
providing an interface between the user device and the storage medium for accessing the indicator; and
in case the information about the type of database cannot be obtained from the storage medium, determining not to enforce the cryptographic network separation functionality on the user device.

2. The method of claim 1, wherein in case the information can be obtained and the indicator is set, evaluating authentication information including a separation indicator received from a network during authentication between the user device and the network, and if the separation indicator is set, proceeding with the authentication, and if the separation indicator is not set, aborting the authentication.

3. The method of claim 1, wherein the indicator on the storage medium is set if the user is homed in a home subscriber system supporting an evolved packet system.

4. A user device comprising:
an interfacing unit configured to interface the user device with a storage medium;
a processing unit configured to check, using the interfacing unit, if an indicator indicating information about a type of database where a user is homed is present on the storage medium, in case the indicator is present, check whether the indicator is set, and in case the indicator is set, evaluate authentication information including a separation indicator received from a network during authentication between the user device and the network.

5. The user device of claim 4, wherein, if the separation indicator is set, the processing unit is configured to proceed with the authentication on the user device, and if the separation indicator is not set, abort the authentication.

6. The user device of claim 5, wherein, if the separation indicator is set, the processing unit is configured to perform key derivation from a ciphering key and an integrity key to obtain a derived key.

7. The user device of claim 4, comprising:
a transmitting unit configured to transmit separation enforcement information to the network in an initial network attachment message.

8. The user device of claim 4, comprising the storage medium.

9. A network system comprising:
a network device managing mobility of a user of the network system; and
a first database supporting a cryptographic network separation functionality, wherein the first database is configured to receive an identity of the user from the network device, and perform key derivation from a ciphering key and an integrity key based on the identity to obtain a derived key,
wherein the network device is provided with information on whether a key derivation from a ciphering key and an integrity key to obtain a derived key is to be performed by the network device.

10. The network system of claim 9,
wherein the first database is configured to store presence and setting of an indicator, located on a storage medium, about a type of database where the user is homed, and receive an identity of the user from the network device, and perform the key derivation from the ciphering key and the integrity key based on the identity to obtain the derived key only in case the indicator is present and set.

11. The network system of claim 9,
wherein the network device is configured to perform the key derivation from the ciphering key and the integrity key to obtain the derived key in case the network device receives separation enforcement information from a user device with a cryptographic network separation functionality which separation enforcement information indicates that no separation enforcement is performed.

12. The network system of claim 9, comprising:
a second database not supporting the cryptographic network separation functionality, wherein the second database is configured to indicate this by separation information,
wherein the network device is configured to perform the key derivation from the ciphering key and the integrity key to obtain the derived key in case the network device receives the separation information from the second database indicating that the cryptographic network separation functionality is not supported by the second database.

13. The network system of claim 9,
wherein the first database is configured to transmit an indication to the network device that it supports the cryptographic network separation functionality, and
the network device is configured to perform the key derivation from the ciphering key and the integrity key to obtain the derived key in case the network device does not receive the indication.

14. A computer-readable storage medium storing a program for causing a computer to execute:
checking if an indicator indicating information about a type of database where a user is homed is present on a storage medium;
in case the indicator is present, checking whether the indicator is set; and
in case the indicator is set, evaluating authentication information including a separation indicator received from a network during authentication between the user device and the network.

15. A storage medium storing an indicator indicating information about a type of database where a user is homed, the storage medium being readable by a user device.
